(19) United States
(12) Patent Application Publication
(10) Pub. No.: US 2002/0026566 A1
(43) Pub. Date: Feb. 28, 2002

(54) DATA BACKUP IN NON-VOLATILE MEMORY

(76) Inventors: KOSAKU AWADA, KANAZAWA (JP); TOSHIMITU HANDA, KANAZAWA (JP); TAKAKI OOSAWA, KANAZAWA (JP); SATOMI DEGUCHI, KANAZAWA (JP); NORIYUKI MIYAMOTO, KANAZAWA (JP); NAMIO HAMANO, KANAZAWA (JP); SATORU YAMAHANA, KANAZAWA (JP)

Correspondence Address: HELFGOTT & KARAS, EMPIRE STATE BUILDING, 60TH FLOOR, NEW YORK, NY, 10118

(21) Appl. No.: 09/245,809

(22) Filed: Feb. 5, 1999

(30) Foreign Application Priority Data
Jun. 8, 1998 (JP) 10-158701

(51) Int. Cl. G06F 12/16

(52) U.S. Cl. 711/162; 711/103; 711/159

(57) ABSTRACT

A method of storing data in a non-volatile memory medium which permits data writing in a memory area after old data thereof is erased is presented. The method includes the steps of providing a data-storage area in each of a plurality of non-volatile memories with respect to each of different data types, and writing incoming data of a given data type in a corresponding data-storage area in a first one of the non-volatile memories while a second one of the non-volatile memories is being subjected to data erasure of the given data type after a corresponding data-storage area in the second one of the non-volatile memories is filled with the incoming data of the given data type.

### BACKGROUND OF THE INVENTION

1. Field of the Invention

The present invention generally relates to a data-backup scheme, and particularly relates to a data-backup scheme which records input data in a non-volatile memory that allows data to be written in a memory area after data is erased therefrom.

2. Description of the Related Art

In recent years, devices for data-transfer systems or the like have been experiencing an increase in size of system data (system-operation data, system-monitor data, and the like), which are necessary for the operation of these devices. It is thus regarded as vital to efficiently record the data in a reliable manner. Also, there is a demand for miniaturization of these devices. Against this background, non-volatile memories (EEPROM) are used as a data-storage medium more often than before as they are smaller than other memory mediums such as bulky hard disks. These non-volatile memories offer a faster data-read/write speed also. Especially, flash EEPROM, one of the variety of non-volatile memories, has a large memory capacity, and is widely used in many devices.

Flash EEPROM has operations of a byte-rewrite-type EEPROM divided into an erase operation and a data-write operation. A given device or a given block (hereinafter called a sector) is erased at once, and, thereafter, data can be electrically written in the erased device or portion. A flash EEPROM of an NOR type is fast in random-read operations because of the device structure thereof, so that this type of EEPROM is often used as a ROM for control of portable equipment or as a data ROM therein. A flash EEPROM of a NAND type is suitable for making a memory of a large capacity because of a device structure thereof, and, also, is controllable by dividing the entire memory space into smaller memory spaces having a predetermined memory size (e.g., 64 kB/sector). This type of EEPROM also offers a high speed operation when block data is written or read by a unit of sector. Because of these characteristics, the flash EEPROM of a NAND type is an appropriate substitute for a hard drive or a floppy disk.

Flash EEPROM has a drawback, however, in that an erasure time for erasing data in a given device or a given sector is lengthy. (For example, it takes about 1.5 to 30 seconds to completely erase one sector.) Another drawback is that sectors other than a sector being erased cannot be accessed while this sector is being erased. Also, only a bit “0” can be rewritten in a device if all bits of the device after erasure of data are “1”, and only a bit “1” can be rewritten in a device if all bits of the device after the erasure of data are “0”. Further, a given device or a given sector is erasable only a limited number of times (e.g., 100 thousand times). In this manner, there are various limitations to be considered when practical application is taken into account.

There is a need for an efficient data-backup scheme which can obviate the limitations described above.

A non-volatile memory media which permits data writing in a memory area after old data thereof is erased includes an optical-magnetic disk, a phase-change-type disc, etc., in addition to the flash EEPROM. The present invention is equally applicable to these non-volatile memory medium as a data-backup method.

FIG. 1 is a block diagram showing a partial configuration of a transmission-line monitoring device used in a related-art data-transmission system having a configuration redundancy. What is shown in FIG. 1 is mainly relates to a backup storage of monitor data.

In FIG. 1, the device includes slots 100 for supporting a package, a circuit board, etc., in a rack-type structure as they are inserted in a replaceable manner, a back plane 101 for establishing signal connections between the circuit boards, and a control board 10 for attending to main control of the transmission line monitoring device. The device further includes a CPU 11 for main control of the control board, a main memory 12 comprised of a RAM, a ROM, etc., for use by the CPU 11, a file board 30 for storing as a backup various monitoring data (line-switch data, line-alarm data, etc.) of the data-transmission system, a CPU 31 for attending to main control of the file board, a main memory 32 used by the CPU 31, and a dual-port RAM 34 for transferring the monitoring data and message communications between the CPU 11 and the CPU 31. The device further includes a flash EEPROM FMEM1 for storing the monitoring data as a backup, a buffer-memory module 36 for accumulating various monitoring data sent from the control board, and buffer memories (RAM) BUF1 and BUF2 each having a memory capacity for one-sector's worth of data.

In the control board 10, the CPU 11 shown in the figure include therein various functional blocks which are implemented via program execution. A communication-control process attends to data-communication control which is necessary in the transmission-line monitoring device. A switch-control process collects and controls monitoring data relating to redundancy switching of lines. An alarm-control process collects and controls various alarm data relating to the lines. An FMEM-management process performs interface processing for storing the collected data in the file board. Each of these processes is implemented as a task, and is executed under the control of OS processes.

In the file board 30, by the same token, an FMEM-control process serves as an interface for exchanging data and messages with the FMEM-management process, and, also, controls data-read/write operations of the file board and erasure-control operations of the flash EEPROM FMEM1. A buffer-evacuation process accumulates in the buffer-memory module 36 various data sent from the control board 10. An FMEM-write process writes the accumulated data in the flash EEPROM FMEM1 by a unit of one block (sector) when the accumulated data becomes full in the buffer memory BUF1 or BUF2. While this is done, an LED (not shown) is flashed for the purpose of informing of an ongoing data-write operation. After the data-write operation is finished, the LED is turned off. The FMEM-write process also controls and updates control data (a sector-operation status flag or the like) stored in a sector-control area, which is provided within each sector. An FMEM-read process directly reads data from the flash EEPROM FMEM1. A sector-erasure process erases a sector which is finished to be used and waits for erasure, and controls and updates control data (the number of times the sector is erased or the like) of the sector-control area. These processes described above are given as a task, and are executed under the control of the OS process.

According to the configuration described above, the related-art data-backup scheme accumulates various data in the buffer-memory module (RAM) 36 when the data is sent from the control board 10, and stores the accumulated data in the flash EEPROM FMEM1 as backup data when the buffer becomes full. Accordingly, one flash EEPROM FMEM1 suffices for the purpose of these operations. Since it is easier to control data if the data is accumulated and classified by data type, the buffer memory BUF1, BUF2, or the like is provided with respect to each data type. A block-write operation with respect to the flash EEPROM FMEM1 is performed via these buffer memories.

FIG. 2 is an illustrative drawing showing a memory map of the related-art flash EEPROM.

The flash EEPROM FMEM1 is provided with a memory area for switch data and a memory area for alarm data. Two sectors, for example, may be allotted to each of these memory areas. In the following, a description will be given with regard to a backup process for the switch data. When a sector SECTOR1, for example, is finished to be used (data writing therein finished), an unused sector SECTOR2 is chosen as a data storage for the next block-data writing, and the obsolete data recorded in the sector SECTOR1 is erased. During a period when the data of sector SECTOR1 is being erased, no data-write operation can be conducted with respect to the sector SECTOR2. Since there is a buffer memory BUF1, no switch data will go missing. The same applies for the sectors SECTOR3 and SECTOR4.

A portion indicated as (a) in FIG. 2 shows a memory map of the sector SECTOR1.

The sector SECTOR1 is provided with a header portion for recording control information regarding the sector SECTOR1 and a data portion for storing the monitoring data.

In the header portion, an operation-status flag indicates the current operation status of the sector SECTOR1. When the sector SECTOR1 is erased, all the bits are set to “1”, and the operation-status flag becomes 0xffff (“0x” indicates a hexa-decimal representation). This pattern specifies that the sector SECTOR1 is unused (erasure completed). Once the sector SECTOR1 is in use, the operation-status flag is changed to 0x1000. Further, the operation-status flag of a given sector is changed to 0x0000 (indicating an unusable status) when the sector wears off.

The number of erasures of the sector SECTOR1 is stored as code information. In detail, data 0x0001 is first stored as the number of erasures. When the number of erasures is stored next time, data 0x0002 is stored in the same field as where the first data 0x0001 is stored or in the next field. The same applies in the case of the other sectors.

As described above, only one flash EEPROM FMEM1 is provided. When the monitoring data is generated in an excessively large amount because of some unexpected reason, the buffer-memory module 36 may overflow since sectors other than a given sector cannot be accessed during a time when the given sector is being erased. This results in a failure to store some of the data. In order to avoid this, the capacity of the buffer-memory module 36 needs to be sufficiently large.

Since only one flash EEPROM FMEM1 is provided, the flash EEPROM FMEM1 after the life thereof expires needs to be replaced by stopping the operation of the file board 30 (by removing the file board 30). Otherwise, data cannot be stored any more. This poses a trouble to a data-backup process.

There is a scheme in which a buffer having one-sector's worth of capacity (e.g., 64 kbytes) is provided with respect to each of the data types, and block data is written in the flash EEPROM FMEM1 when the buffer becomes full. Since the block writing of data takes a lengthy time, if new monitoring data is generated during a time of the block writing, a delay is generated in terms of writing next data in a buffer. Also, there is a risk of having a power cut while the data is accumulated in the buffer-memory module 36. If this happens, the data accumulated in the buffer-memory module 36 will be lost.

In the configuration described above, control information regarding a given sector is recorded within this sector. In such a configuration, each time a given sector is erased, the control information (e.g., the number of erasures) stored in this sector before the erasure thereof needs to be evacuated to an external RAM or the like. If a power cut occurs when the data is evacuated, the data being evacuated will be lost. This results in accurate management of sector life being undermined.

Further, when sectors are fixedly allocated to each data type, it is possible to encounter shortage of unused sectors. This may happen when one of the sectors wears off because of an expiration of life or when a large number of data-write operations are generated in a burst-like manner with respect to a particular data type.

Moreover, when the number of erasures is recorded as code information in a plurality of different fields, a large number of memory fields are necessary. This hampers an effort to make an efficient use of memory space.

As described above, the ongoing data-write operation with respect to the flash EEPROM FMEM1 is indicated by the flashing LED or the like. It is possible, however, to overlook the flashing LED so that the file board may be accidentally removed during the data-write operation. Also, a power-cut operation may be conducted at a time around the start of the flashing, resulting in storage of erroneous data.

Accordingly, there is a need for a data-backup scheme which can perform an efficient and reliable data-backup operation in a non-volatile memory that allows new data to be written in a memory area after old data thereof is erased.

### SUMMARY OF THE INVENTION

Accordingly, it is a general object of the present invention to provide a data-backup scheme which can satisfy the need described above.

It is another and more specific object of the present invention to provide a data-backup scheme which can perform an efficient and reliable data-backup operation in a non-volatile memory that allows new data to be written in a memory area after old data thereof is erased.

In order to achieve the above objects according to the present invention, a method of storing data in a non-volatile memory medium which permits data writing in a memory area after old data thereof is erased includes providing a data-storage area in each of a plurality of non-volatile memories with respect to each of different data types, and writing incoming data of a given data type in a corresponding data-storage area in a first one of the non-volatile memories while a second one of the non-volatile memories is being subjected to data erasure of the given data type after a corresponding data-storage area in the second one of the non-volatile memories is filled with the incoming data of the given data type.

In the method described above, new incoming data of the given data type following previous incoming data is readily recorded in the first one of the non-volatile memories without any delay even when the second one of the non-volatile memories is being erased. This insures that a backup of the new incoming data is efficiently made in a reliable manner.

According to another aspect of the present invention, a method of storing data in a non-volatile memory medium which permits data writing in a memory area after old data thereof is erased includes the steps of providing control-data areas for respective non-volatile memories in each of the non-volatile memories such that each of the control-data areas stores operation statuses of a corresponding one of the non-volatile memories, and copying contents of a control-data area in a first one of the non-volatile memories to a control-data area in a second one of the non-volatile memories before erasing the control-data area in the first one of the non-volatile memories, thereby effecting continued control of the operation statuses of a corresponding one of the non-volatile memories.

In the method described above, when data is erased from the first one of the non-volatile memories, the second one of the non-volatile memories can be used for continuously managing the operation statuses of the non-volatile memories.

Furthermore, since the operation statuses of the non-volatile memories are recorded in the non-volatile memory medium, external factors such as a power-on/off condition of the device are not relevant in the management of the non-volatile memories, so that the operation statuses of the non-volatile memories are reliably managed.

According to another aspect of the present invention, a method of storing data in a non-volatile memory medium which permits data writing in a memory area after old data thereof is erased includes the steps of providing a memory area which stores a number of occurrences of a given event in a non-volatile memory, setting a first bit state in all bits of the memory area as initialization thereof, and changing one of predetermined bits of the memory area from the first bit state to a second bit state each time the given event occurs, thereby counting the number of occurrences of the given event without a need for erasing the memory area.

Since a change from the first bit state to the second bit state as described above can be made without first deleting the memory area, this counting operation is quick and saves memory space.

Other objects and further features of the present invention will be apparent from the following detailed description when read in conjunction with the accompanying drawings.

### BRIEF DESCRIPTION OF THE DRAWINGS

FIG. 1 is a block diagram showing a partial configuration of a transmission-line monitoring device used in a related-art data-transmission system;

FIG. 2 is an illustrative drawing showing a memory map of a related-art flash EEPROM;

FIG. 3 is an illustrative drawing for explaining a principle of the present invention;

FIG. 4 is a block diagram for implementing a data-backup scheme according to an embodiment of the present invention;

FIGS. 5 and 6 are illustrative drawings for explaining a memory map of a flash memory according to the embodiment of the present invention;

FIGS. 7A and 7B are table charts for explaining recursive use of flash-memory sectors;

FIG. 8 is an illustrative drawing for explaining a memory map of a buffer-memory module according to the embodiment of the present invention;

FIG. 9 is a flowchart of a data-backup process according to the embodiment of the present invention;

FIG. 10 is a flowchart of a data-evacuation process storing data in a data-evacuation buffer;

FIG. 11 is a flowchart of a data-write process transferring data from the data-evacuation buffer to a flash EEPROM; and

FIG. 12 is a flowchart of a sector-erasure process.

### DESCRIPTION OF THE PREFERRED EMBODIMENTS

In the following, a principle and embodiments of the present invention will be described with reference to the accompanying drawings.

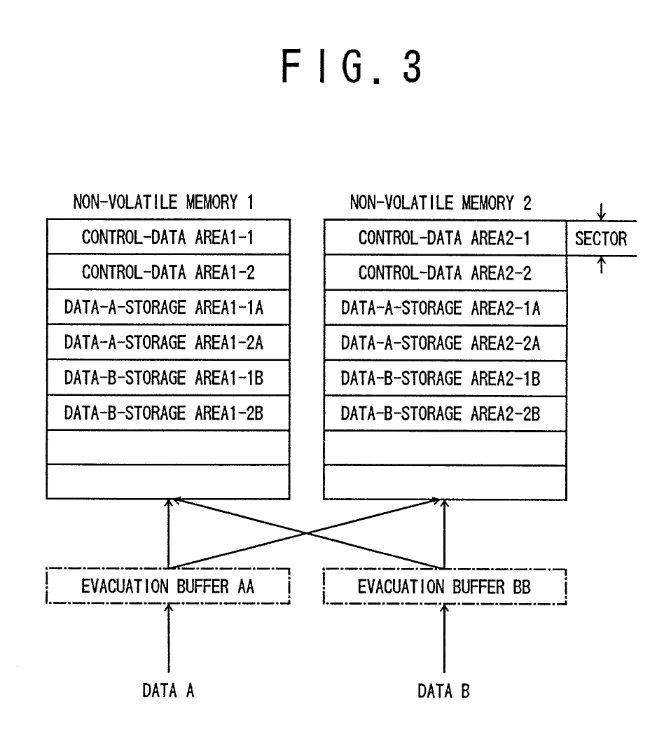

FIG. 3 is an illustrative drawing for explaining a principle of the present invention.

A data-backup scheme of FIG. 3 uses a non-volatile memory that allows new data to be written in a memory area after old data thereof is erased. In the data-backup scheme of FIG. 3, data-storage areas for storing data of the same data type are provided in respective non-volatile memories, and given data is written in one of the non-volatile memories when the other one of the non-volatile memories is attending to erasure of data of the same type recorded therein.

FIG. 3 shows a case in which two memories are provided. The number of memories, however, can be three or more. It would facilitate the understanding of the present invention if the Flash EEPROMs are taken as an example of the non-volatile memories.

In the figure, data of the same type (e.g., data A) is recorded in data-storage areas (data-A-storage areas), which are respectively provided in non-volatile memories 1 and 2. When the non-volatile memory 1 is attending to the erasure of the data A, new data A of the same type is written in the non-volatile memory 2.

Accordingly, new data A following previous data is readily recorded in the non-volatile memory 2 without any delay even when the non-volatile memory 1 is being erased. This insures that a backup of new data is efficiently made in a reliable manner.

According to another aspect of the present invention, the non-volatile memories allow recorded data to be erased by a unit of one block (sector), and a plurality of sectors are allocated as a data-storage area to a given data type in a given non-volatile memory.

In the configuration described above, for example, two sectors are allocated to the data type A in each of the non-volatile memories 1 and 2, and are indicated as data-A-storage areas 1-1A and 1-2A in the non-volatile memory 1 and as data-A-storage areas 2-1A and 2-2A in the non-volatile memory 2. This configuration make it possible to write data A in the data-A-storage area 1-2A of the non-volatile memory 1 immediately after the data A is written in the data-A-storage area 1-1A of the non-volatile memory 1. In this operation, the data-A-storage area 1-1A having old data recorded therein is not erased, thereby sustaining the old data A for some time in an attempt to insure reliability. Also, there is no delay to the data-write operation directed to the data-A-storage area 1-2A.

After the data A is written in the data-A-storage area 1-2A of the non-volatile memory 1, it is possible to write the data A in the data-A-storage area 2-1A of the non-volatile memory 2. At this time, the data-A-storage areas 1-1A and 1-2A of the non-volatile memory 1 can be erased without causing any delay to the writhing of data A in the non-volatile memory 2.

In this manner, the data A is written in each sector in a distributed manner, and is erased by a unit of one sector. Because of this, distributed processing of erasure operations is achieved, and an erasure time can be shortened. Further, even when the data A is generated in a burst-like manner, all the data A can be stored without losing a piece. In this manner, an efficient and reliable backup operation can be performed.

According to another aspect of the present invention, an evacuation buffer implemented via a volatile memory is provided for each data type. In a normal operation, new data is initially stored in the evacuation buffer, and, then, the data stored therein is immediately transferred to a non-volatile memory. If the non-volatile memory is not in condition for accepting the writing of data, the data is successively accumulated in the evacuation buffer. When the non-volatile memory becomes available for the writing of data, the data accumulated in the evacuation buffer is written in the non-volatile memory.

In detail, evacuation buffers AA and BB are provided for the data type A and B, respectively. In a normal operation, input data (new data) A is initially stored in the evacuation buffers AA, and, then, the data A recorded therein is immediately transferred to the non-volatile memory 1, for example. If the non-volatile memory 1 is not in condition for accepting data writing (as when a data-B-storage area 1-1B is being erased), the input data A is accumulated in the evacuation buffer AA. When the non-volatile memory 1 becomes available for data writing (as when the erasure of the data-B-storage area 1-1B is finished), the data accumulated in the evacuation buffer AA is written in the non-volatile memory 1.

In this manner, the present invention has a basic mode of operation in which the input data is written in the non-volatile memories 1 and 2, and the evacuation buffers AA and BB play a secondary role serving as an auxiliary data-evacuation means, which is used only when a data writing operation needs to wait. In this configuration, it is unlikely to lose data even when an unexpected power cut occurs.

According to another aspect of the present invention, a replacement enabling means is provided in order to control a locked/unlocked condition of the non-volatile memories in terms of whether they are locked in place. When the evacuation buffers hold data that has not been stored in the non-volatile memories, the replacement enabling means is put in the locked condition.

Namely, when the evacuation buffer AA hold the data A that has not been stored in the non-volatile memory 1 or the non-volatile memory 2, the non-volatile memory 1 or 2 is placed in a locked condition so as to prevent removal of the non-volatile memory 1 or 2. In this manner, the data A is reliably stored in the non-volatile memory, and this configuration prevents a user from accidentally removing the non-volatile memories.

According to another aspect of the present invention, control-data areas for recording operation statuses of the respective non-volatile memories are provided in each of the non-volatile memories, and when a given control-data area in a given non-volatile memory is erased, the most updated control data of the given control-data area prior to the erasure is copied to a control-data area of another non-volatile memory, so that the operation statuses of the non-volatile memories can be so managed as to maintain continuity of management.

Namely, operation statuses (e.g., being used, finished being used, and waiting for erasure) regarding each of the non-volatile memories 1 and 2 are stored in a respective control-data area, which is in turn provided in each of the non-volatile memories 1 and 2. When a given control-data area 1-1 is to be erased in the non-volatile memory 1, the most updated data of the control-data area 1-1 is copied to a control-data area 2-1 of the non-volatile memory 2 before the erasure is carried out. In this manner, a continuity is maintained in the management of the operation statuses regarding the non-volatile memories 1 and 2.

When data is erased from the non-volatile memory 1, therefore, the non-volatile memory 2 can be used for continuously managing the operation statuses of the non-volatile memories 1 and 2.

Furthermore, since the operation statuses of the non-volatile memories 1 and 2 are recorded in the non-volatile memory medium, external factors such as a power-on/off condition of the device are not relevant in the management of the non-volatile memories 1 and 2, so that the operation statuses of the non-volatile memories 1 and 2 and life thereof are reliably managed.

According to another aspect of the present invention, the non-volatile memories allow recorded data to be erased by a unit of one block (sector), and a plurality of sectors are allocated to each of the control-data areas in each of the non-volatile memory.

Namely, the non-volatile memories 1 and 2 have two sectors allocated to each of the control-data areas therein, for example.

After checking the operation statuses by accessing the control-data area 1-1 of the non-volatile memory 1, for example, a control-data area 1-2 of the non-volatile memory 1 may be used to check the operation statuses. At this time, the old control-data area 1-1 is not erased, so that old control data can be maintained for some time in order to insure reliability. Also, there is no delay to data access to the control-data area 1-2. After using the control-data area 1-2 of the non-volatile memory 1, a control-data area 2-2 of the non-volatile memory 2 may be used for management of the operation statuses. Even if the control-data areas 1-1 and 1-2 of the non-volatile memory 1 are erased at this time, data access to the non-volatile memory 2 is not affected at all. This configuration thus insures an effective and reliable management with respect to each of the non-volatile memories.

According to another aspect of the present invention, the control-data areas can be used for the management of operation statuses on a sector-wise basis with respect to each of the non-volatile memories. A sector-wise operation management is thus insured, and is effective and reliable as well.

According to another aspect of the present invention, a plurality of sectors are used for the management of a given non-volatile memory, and, then, another set of sectors are used for the management of anther non-volatile memory. The plurality of sectors allocated to the former non-volatile memory are subjected to erasure of data at an appropriate timing, so that these sectors become available for next use. In this manner, a plurality of sectors are recursively used for a plurality of non-volatile memories.

Namely, two sectors, for example, are used for the non-volatile memory 1, and, then, another two sectors is used for the non-volatile memory 2. At an appropriate timing, the two sectors allocated to the non-volatile memory 1 are subjected to erasure of data thereof, so that the two sectors are recursively used. This can make an efficient use of the limited memory capacity with respect to the non-volatile memories 1 and 2 in order to accommodate various data types.

According to another aspect of the present invention, if a non-volatile memory needs to be replaced while another non-volatile memory is being used, used sectors of the latter non-volatile memory are subjected to erasure.

Namely, just at a time when the data-A-storage area 1-2A needs to be used after using the data-A-storage area 1-1A, another non-volatile memory 2 may need to be replaced because a life thereof has expired, for example. In this case, the old data-A-storage area 1-1A is erased. Because of this operation, writhing of data A can continue without a need for stopping the system in order to replace the non-volatile memory 2.

According to another aspect of the present invention, if a shortage of sectors occurs, other sectors are immediately allocated.

If the amount of data A is increased, for example, or if no unused data-A-storage area can be found either in the non-volatile memory 1 or in the non-volatile memory 2 after using the data-A-storage areas 1-1A and 1-2A in the non-volatile memory 1, other sectors are newly allocated for use as another data-A-storage area. If other sectors are not available, sectors allocated to another data type B, for example, may change an allocation thereof so as to be used for the data type A. Such a flexible reallocation of sectors can prevent loss of data when the data needs to be stored.

According to another aspect of the present invention, a memory area for storing a count as to how may times a particular event occurred is provided in a non-volatile memory, and predetermined bits in the memory area are set to all “1” or all “0”, which constitutes an initial pattern. Each time the particular event occurs, a certain bit of the predetermined bits is changed from “1” to “0” or from “0” to “1”, so that the number of event occurrences can be kept on record.

For example, the initial pattern of the memory area may be 0xffff (“0x” indicates hexa-decimal representation). When a first event (such as an erasure of data) occurs, the least significant bit is dropped so as to create 0xfffe. When a second event occurs, the second least significant bit is dropped, so that the pattern becomes 0xfffc. The same procedure is followed thereafter. Since such a change of a single bit can be made without first deleting the memory area, this counting operation is quick and saves memory space.

According another aspect of the present invention, the non-volatile memories are flash EEPROMs. The principle of the present invention described above is quite suitable for a data-backup application using flash EEPROMs.

In the following, embodiments of the present invention will be described with reference to the accompanying drawings. Throughout the drawings, the same elements or equivalent elements are referred to by the same numerals.

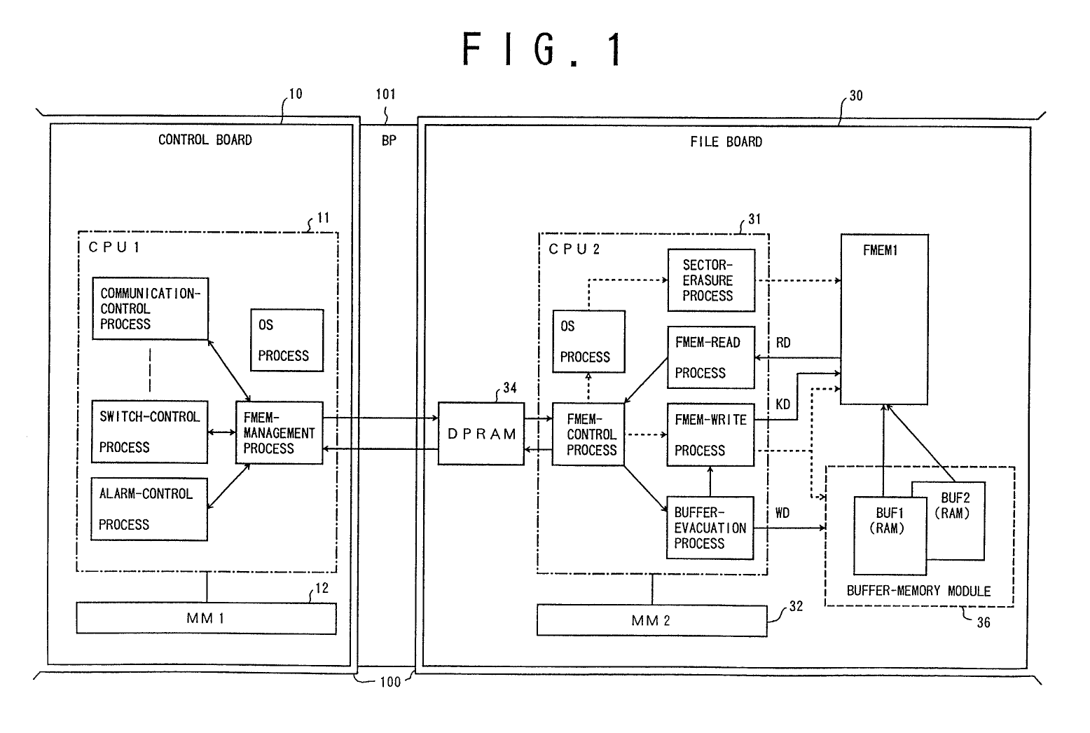

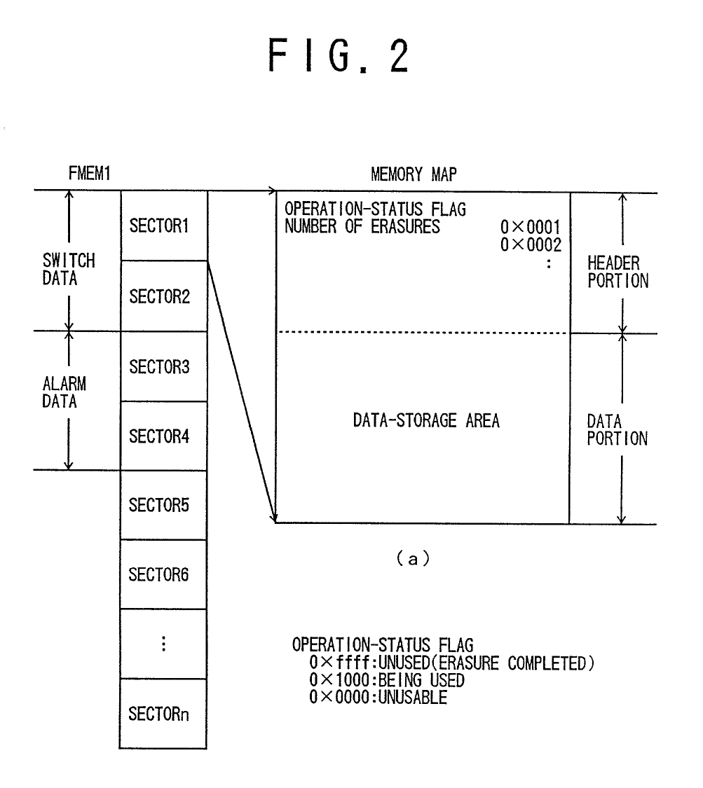

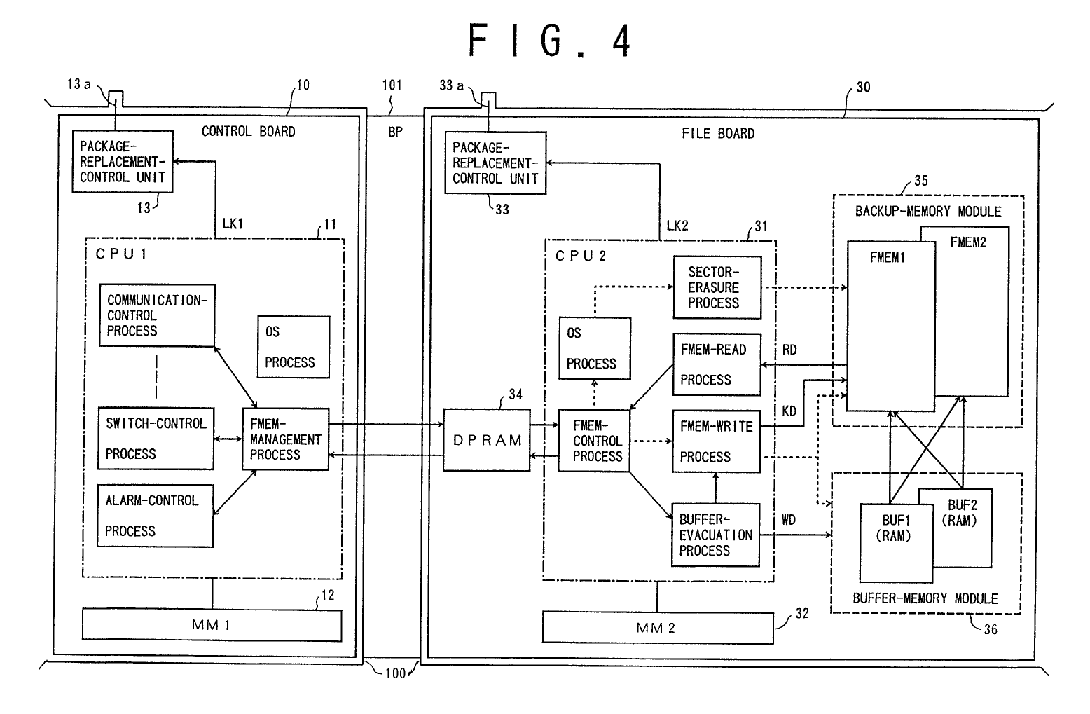

FIG. 4 is a block diagram for implementing the data-backup scheme according to an embodiment of the present invention. As does FIG. 1, FIG. 4 shows a partial configuration of a transmission-line monitoring device used in a data-transmission system having a configuration redundancy. What is shown in FIG. 4 is mainly relates to a backup storage of monitoring data.

The device of FIG. 4 includes the control board 10, the CPU 11, the main memory 12, a package-replacement-control unit 13 for restricting removal of the control board, a lock pin 13a offering a locking function along with the package-replacement-control unit 13, the file board 30, the CPU 31, the main memory 32, a package-replacement-control unit 33, a lock pin 33a, the dual-port RAM 34, a backup-memory module 35 for storing a non-volatile backup copy of various monitoring data (line-switch data, line-alarm data, etc.) and control data relating to management of the monitoring data, the flash EEPROM FMEM1, a flash EEPROM FMEM2, the buffer-memory module 36 serving as a temporal storage for the various monitoring data sent from the control board, and the buffer memories BUF1 and BUF2.

In the control board 10, the communication-control process attends to data-communication control which is necessary in the transmission-line monitoring device. The switch-control process collects and controls monitoring data relating to redundancy switching of lines. The alarm-control process collects and controls various alarm data relating to the lines. The FMEM-management process preforms interface processing for storing the collected data in the file board. Each of these processes is implemented as a task, and is executed under the control of OS processes.

In the file board 30, the FMEM-control process serves as an interface for exchanging data and messages with the FMEM-management process, and, also, controls data-read/write operations of the file board and erasure-control operations of the flash EEPROMs FMEM1 and FMEM2. The buffer-evacuation process temporarily stores in the buffer-memory module 36 various data sent from the control board 10. The FMEM-write process writes the data of the buffer memories BUF1 or BUF2 in the flash EEPROM FMEM1 or FMEM2 promptly, and controls and updates the control data (a sector-operation-status flag, a data type, etc.) of the control sectors if necessary. The FMEM-read process directly reads data from the flash EEPROM FMEM1 or FMEM2. The sector-erasure process erases a sector waiting for erasure, and controls and updates control data (the number of times the sector is erased or the like) of the control sectors if necessary. These processes described above are given as a task, and are executed under the control of the OS process.

The package-replacement-control unit 13 is provided with a solenoid mechanism unit or the like (not shown). When a lock signal LK1 supplied from the CPU 11 is 1, the lock pin 13a is pushed upward in the figure so as to lock the control board 10 and prevent same from being taken out from the slot 100. When the lock signal LK1 is zero, the lock pin 13a is retracted so as to unlock the control board 10. In this condition, the control board 10 can be removed from the slot 100. The package-replacement-control unit 33 works in the same manner.

Although not shown in the figure, the control board 10 is provided with a status register for storing a power-off status regarding power-switch operations. When the power-off status is 1, the CPU 11 stops power supply to the device.

The backup-memory module 35 includes at least two flash EEPROM devices (FMEM1 and FMEM2). Each device may have a memory capacity of 512 kbytes, and is comprised of 8 sectors where each sector is 64 k bytes. A sector-wise erasure is possible with respect to each device. It takes 1.5 to 30 seconds to erase one sector, for example. Data access cannot be made to a device while any sector of the device is subjected to a data erasure process. Only a limited number of erasures can be made (e.g., 100 thousand times). In this example, the flash EEPROMs have all the bits thereof set to “1” after erasure (reset) thereof, so that only bits “0” can be rewritten. Alternatively, of course, a device may be chosen such that all the bits thereof after erasure are set to “0” so as to allow only rewriting of bits “1”.

In the buffer-memory module 36, evacuation buffers BUFx (x=1, 2, . . . ) are provided as many as there are data types. In this example, the buffer BUF1 is provided for the switch data, and the buffer BUF2 is provided for the alarm data. It is apparent that a single RAM device may be used with a memory area thereof divided into the buffers BUF1 and BUF2. The evacuation buffers are selectable by programs, and it does not matter which buffer is used for the switch data or the alarm data.

In the data-backup scheme according to the embodiment of the present invention, various data sent from the control board 10 are immediately stored in the backup-memory module 35, and this is a basic mode of operation. The buffer-memory module 36 is provided only as a temporary data-evacuation means used when data writing needs to be deferred.

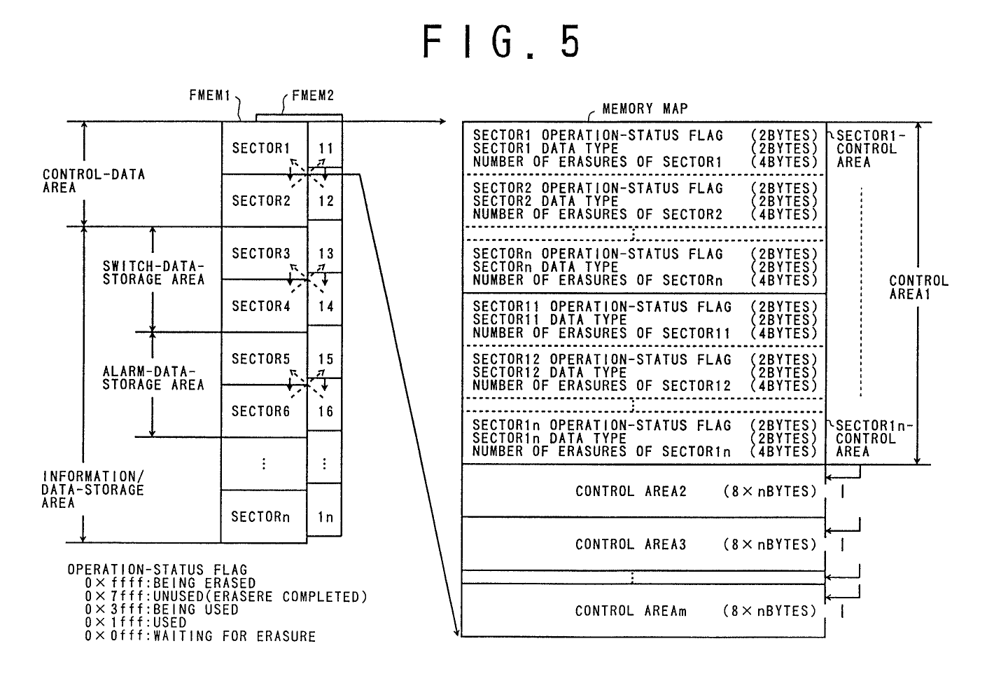

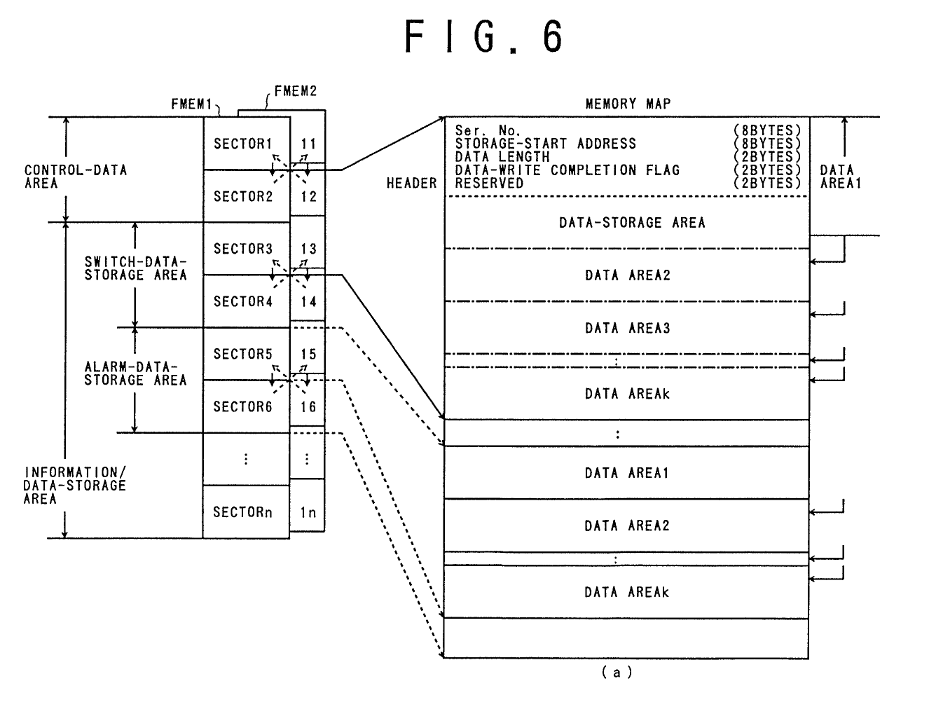

FIGS. 5 and 6 are illustrative drawings for explaining a memory map of a flash memory (flash EEPROM) according to the embodiment of the present invention.

The following description will be given with respect to the flash EEPROM FMEM1. It should be noted, however, that everything given in the description should equally apply in the case of the flash EEPROM FMEM2. Further, sectors SECTOR11 through SECTOR1n of FMEM2 are given these designations for the purpose of distinguishing from sectors SECTOR1 through SECTORn of FMEM1, and can be referred as FMEM2 sectors SECTOR1 through SECTORn, for example.

FIG. 5 shows details of a control-data area of the flash EEPROM FMEM1.

The flash EEPROM FMEM1 includes a control-data area (sectors SECTOR1 and SECTOR2) and an information/data-storage area (sectors SECTOR3 through SECTORn).

A portion indicated as (a) shows a memory map of the sector SECTOR1 in the control-data area.

The sector SECTOR1 includes m control areas CONTROL-AREA1 through CONTROL-AREAm. The control area CONTROL-AREA1 includes a SECTOR1-control area through a SECTOR1n-control area, the total number of which is 2n. Since n is 8 in this example, the SECTORl-control area has a size of 128 bytes (8×16). The number m is thus 500 (64 k /128).

The SECTOR1-control area of the sector SECTOR1 is used for controlling the operation statuses of the sector SECTOR1 itself. The SECTOR2-control area is used for controlling the operation statuses of the sector SECTOR2. By the same token, the SECTOR1n-control area is used for controlling the sector SECTOR1n

Because of this configuration, the control area CONTROL-AREA1 of the sector SECTOR1 can be used for controlling all the sectors SECTOR1 through SECTORn and the sectors SECTOR11n through SECTOR1n. When updating of control data cannot be done in a given SECTORi-control area (e.g, when there is a need to rewrite bit “0” to bit “1”), all the information of the sector-control area CONTROL-AREA1 is copied to the sector-control area CONTROL-AREA2 to carry out continued management. When this is done, the SECTORi-control area where the updating of data cannot be made is not subjected to copying of the data thereof. Instead, the portion (e.g., relating to the number of erasures) where the updating of data cannot be made is initialized so as to make it possible to carry out continued management.

In the following, the contents of the SECTOR1-control area will be described.

The operation-status flag (2 bytes) represents operation statuses of a pertinent sector which is to be managed by this area. If the sector SECTOR1 is erased (reset), all the bits of the operation-status flag become “1”. That is, the flag becomes 0xffff. After this, “0” is written in a pertinent bit as a change takes place in operation statuses of the pertinent sector. In this manner, various operation statuses can be represented without erasing the sector SECTOR1. The following is a list of various contents of the operation-status flag and the meanings thereof:

“erased”: 0xffff (all bits are “1” because of erasure);

“unused (after erasure)”: 0x7fff (the 15-th bit is set to “0”);

“being used”: 0x3fff

(the 14-th bit is set to “0”);

“used”: 0xlfff (the 13-th bit is set to “0”);

“waiting for erasure”: 0xOfff (the 12-th bit is set to “0”); and

“unusable (e.g., life expired)”: a code other than the above-listed codes.

The data type represents a data type to be stored in the pertinent sector. The following is a list of data types and codes thereof:

data type of sectors SECTOR1 and SECTOR2=control data: 0x1000;

data type of sectors SECTOR3 and SECTOR4=switch data: 0x0001; and

data type of sectors SECTOR5 and SECTOR6=alarm data: 0x0010.

Here, the control data is used for controlling the sectors SECTOR1 through SECTORn and SECTOR11 through SECTOR1n, and the switch data relates to a redundancy switch history of the data-transmission system which has a dual redundancy structure. Also, the alarm data represents an alarm history relating to a communication-line failure, a bit-error rate, etc.

The number of erasures (4 bytes) represents the number of times the pertinent sector is erased. A field which contains the number of erasures serves as a counter. The two bytes of the field on the least significant side thereof are used for counting the number of erasures up to 16 without a need for erasure of the sector SECTOR1. The counting is carried out by dropping one bit after another starting from the least significant bit each time the pertinent sector is erased. The two bytes of the field on the most significant side thereof are used for counting the number of erasures as a multiple of 16 based on a binary-coded-decimal scheme, so that a count up to 64 thousands can be made. In total, therefore, the number of erasures up to 64,000×16 (nearly equal to 1.02 million) can be counted. This easily covers a range of a maximum number of erasures of an ordinary flash EEPROM, which is about ten thousands.

The following is examples of the contents of the number of erasures (transitions):

upon reset: 0xfffffff (all the bits are “1” because of the erasure);

upon writing of an initial value: 0x0000ffff (this is when an initial value is written in the control area CONTROL-AREA1);

upon first erasure: 0x0000fffe (the least significant bit (LSB) is dropped);

upon second erasure: 0x0000fffc (the second least significant bit is dropped);

upon 16-th erasure: 0x00000000 (the 16-th bit from the LSB is dropped);

upon change of control area: 0xffffffff (all the bits are set to “1”);

upon writing of an initial value: 0x0001ffff (this is when an initial value is written in the control area CONTROL-AREA2);

upon 17-th erasure: 0x0001fffe (the LSB is dropped); and

upon 18-th erasure: 0x0001fffc (the second LSB is dropped).

A change from the control area CONTROL-AREA1 to the control area CONTROL-AREA2 as shown in the above is made when the number of erasures exceeds 16 with regard to any one of the sectors. Namely, when the number of erasures of a given sector becomes 0x00000000 upon a 16-th erasure, any numbers higher this number cannot be counted by using the control area CONTROL-AREA1. In this case, all the information of the control area CONTROL-AREA1, except for the field that contains the number of erasures (=0x00000000), is copied to the control area CONTROL-AREA2. Since the corresponding field containing the number of erasures in the control area CONTROL-AREA2 is set to 0xffffffff in advance, an initial value 0x0001ffff is written in this field. The same steps are followed thereafter, so that the two bytes of the counter on the most-significant-bit side can be continuously changed without a need to erase the sector SECTOR1 until the control area CONTROL-AREAm is used. Namely, the sector SECTOR1 can be used for counting the number of erasures of a given sector up to 8000 (=m×16, m: 500) without a need to erase the sector SECTOR1.

When all the control areas are used in the sector SECTOR1, the sector SECTOR2 is used next. When the sector SECTOR2 is used up, then, the sector SECTOR11 is used. Preferably, during a time when the sector SECTOR11 is used, the control data in the sectors SECTOR1 and SECTOR2 are erased. After the sector SECTOR11 is used up, the sector SECTOR12 is used. Until the time when the sector SECTOR12 is used up, the number of erasures up to 32,000 (=8,000×4) can be counted continuously with respect to a given sector. After the sector SECTOR12 is used up, the sector SECTOR1 which has been already erased by this time will be used again. Such a recursive use of sectors makes it possible to count the number of erasures exceeding the above number.

FIG. 6 shows details of an information/data-storage area of the flash EEPROM FMEM1.

The information/data-storage area (sectors SECTOR3 through SECTORn) includes sectors provided for each of the data types. That is, each of the switch data and the alarm data has two sectors allocated thereto. In the following, a description will be given with regard to the switch data. However, the same applies in the case of the alarm data.

A portion indicated by (a) shows a memory map of the sector SECTOR3 of the switch-data storage area.

The sector SECTOR3 includes k data areas DATA-AREA1 through DATA-AREAk. The data area DATA-AREA1 includes a header area and a data-storage area.

The following is an exemplary list of items included in a data area:

Serial No. (8 bytes):

ordinal number assigned to stored data;

Storage-Start Address (8 bytes):

a start address of an area where data is stored;

Data Length (2 bytes):

size of the stored data;

Data-Write-Completion Flag (2 bytes):

flag indicative of completion of data writing (0x5aa5); and

Data-Storage Area:

area where real data (size of which can be set to any amount) is stored.

When the first switch data is generated, it is written in the data area DATA-AREA1 of the sector SECTOR3. Upon generation of the second switch data, the second switch data is stored in the data area DATA-AREA2 of the sector SECTOR3. This continues thereafter until the k-th switch data is stored in the data area DATA-AREAk of the sector SECTOR3. After all the data areas in the sector SECTOR3 is used up, the sector SECTOR4 will be used. When the sector SECTOR4 is used up, the sector SECTOR13 will be used. Preferably, during a time when the sector SECTOR13 is used, the switch data in the sectors SECTOR3 and SECTOR4 are erased. After the sector SECTOR13 is used up, the sector SECTOR14 is used. When the sector SECTOR14 is used up, the sector SECTOR3, which has been already erased by this time, will be used again. In this manner, the sectors SECTOR3, SECTOR4, SECTOR13, and SECTOR14 will be used for continuously writing the switch data therein

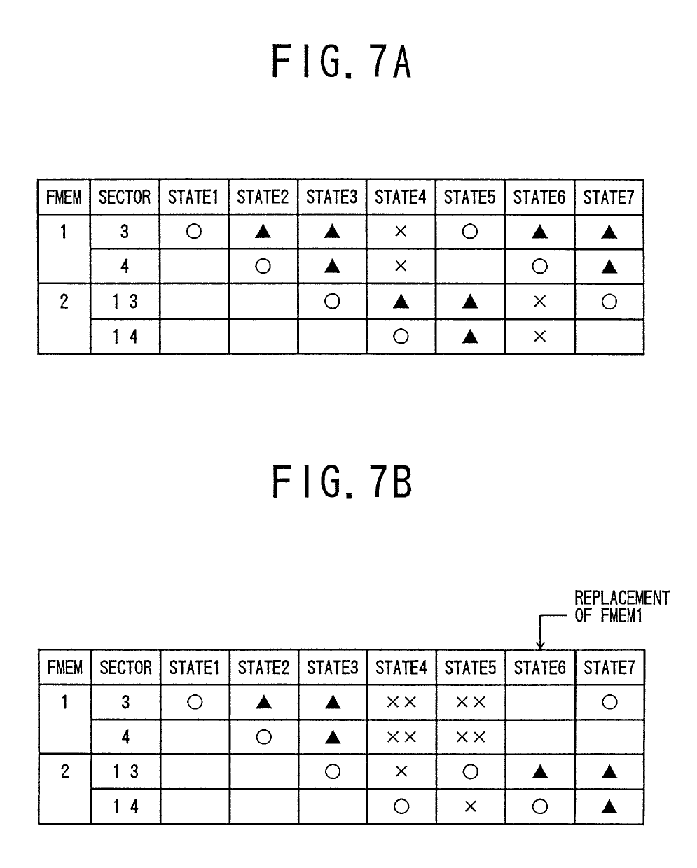

FIGS. 7A and 7B are table charts for explaining recursive use of the flash memory sectors. FIG. 7A shows a case in which the life of the flash EEPROM has not yet expired. Since the switch data is used as an example, the sectors SECTOR3 and SECTOR4 of the flash EEPROM FMEM1 and the sectors SECTOR13 and SECTOR14 of the flash EEPROM FMEM2 are subjected to the recursive use.

In the figure, each symbol represents the operation-status flag of a respective sector. A blank indicates an “unused (after completion of erasure)” condition. A symbol “O” indicates “being used”, and a symbol “▴” indicates “used/waiting for erasure”. Further, a symbol “X” indicates “being erased”, and a symbol “XX” indicates “unusable (life expired)”.

In a first state, the operation-status flag of the SECTOR3-control area in the sector SECTOR1 is set to “being used”. Each switch data generated thereafter is stored in the data areas DATA-AREA1, DATA-AREA2, and so on, successively. When k-th switch data is stored in the sector SECTOR3, a shift is made to a second state.

In the second state, the operation-status flag of the SECTOR3-control area in the sector SECTOR1 is changed to “used”, and the operation-status flag of the SECTOR4-control area is set to “being used”. Each switch data generated thereafter is successively stored in the sector SECTOR4 at the data areas DATA-AREA1, DATA-AREA2, and so on. When k-th switch data is stored in the sector SECTOR4, another shift is made to a third state.

In the third state, the operation-status flag of the SECTOR4-control area in the sector SECTOR1 is changed to “used”, and the operation-status flag of the SECTOR13-control area is set to “being used”. Each switch data generated thereafter is stored in the sector SECTOR13 at the data areas DATA-AREA1, DATA-AREA2, and so on, successively. When k-th switch data is stored in the sector SECTOR13, another shift is made to a fourth state.

In the fourth state, the operation-status flag of the SECTOR13-control area in the sector SECTOR1 is changed to “used”, and the operation-status flag of the SECTOR14-control area is set to “being used”. Each switch data generated thereafter is stored in the sector SECTOR14 at the data areas DATA-AREA1, DATA-AREA2, and so on, successively.

During this time period, there is no need to write data in the flash EEPROM FMEM1. Accordingly, the operation-status flags of the SECTOR3-control area and the SECTOR4-control area are changed to “waiting for erasure”. Upon this change in the flags, the sectors SECTOR3 and SECTOR4 are successively erased. When the erasures are complete, the operation-status flags of the SECTOR3-control area and the SECTOR4-control area in the sector SECTOR1 need to be set to “unused (after completion of erasure)”.

At this point, however, the operation-status flags of the SECTOR3-control area and the SECTOR4-control area in the sector SECTOR1 keep therein the bit pattern 0x0fff indicative of “waiting for erasure”. These operation-status flags thus cannot be bring back to the bit pattern 0xffff indicative of “unused” unless the sector SECTOR1 is erased. In this case, therefore, a set of four bits “f” which is the third set from the LSB side of an operation-status flag is used, so that control and updating of the operation-status flags can be continuously carried out without erasing the sector SECTOR1.

The number of erasures in each of the SECTOR3-control area and the SECTOR4-control area is changed from 0x0000ffff to 0x0000fffe. After this point, 0x0000fffe is referred to as the number of erasures, such that the number of erasures is tied up with the effective portion of the operation-status flags. For example, a check of the number of erasures reveals that the four bits “f” of the third four-bit set from the LSB side of the operation-status flags are currently in use. When the number of erasures becomes 0x0000fffc in the SECTOR3-control area and the SECTOR4-control area, four bits “f” of the second four-bit set from the LSB side of the operation-status flags will be used for controlling and updating of the operation-status flags. In this manner, the controlling and updating of the operation-status flags can be continuously conducted without erasing the sector SECTOR1.

In this configuration, however, the number of erasures can be counted continuously up to 16, whereas the operation-status flags can be continuously used for only a count up to 4. If this imbalance needs to be addressed, the number of bits may be increased in the operation-status flags. For example, the operation-status flag may be provided with 8 bytes, which are set to 0xffffffffffffffff.

Alternatively, the control area used in the sector SECTOR1 may be shifted successively from the control area CONTROL-AREA1 to the control area CONTROL-AREA2, from the control area CONTROL-AREA2 to the control area CONTROL-AREA3, and so on.

In the fourth state previously described, no erasure process is performed on the flash EEPROM FMEM2, so that there is no delay with respect to the writing of data in the sector SECTOR14. When k-th switch data is written in the sector SECTOR14, yet another shift is made to a fifth state.

In the fifth state, the operation-status flag of the SECTOR14-control area in the sector SECTOR1 is changed to “used”, and the operation-status flag of the SECTOR3-control area is set to “being used”. Each switch data generated thereafter is stored in the sector SECTOR3 at the data areas DATA-AREA1, DATA-AREA2, and so on, successively. When k-th switch data is stored in the sector SECTOR3, another shift is made to a sixth state.

In the sixth state, the operation-status flag of the SECTOR3-control area in the sector SECTOR1 is changed to “used”, and the operation-status flag of the SECTOR4-control area is set to “being used”. Each switch data generated thereafter is stored in the sector SECTOR4 at the data areas DATA-AREA1, DATA-AREA2, and so on, successively. During this time period, there is no need to write data in the flash EEPROM FMEM2, so that the operation-status flags of the SECTOR13-control area and the SECTOR14-control area are changed to “waiting for erasure”. When k-th switch data is stored in the sector SECTOR4, another shift is made to a seventh state. The same procedure as described above is repeated thereafter.

FIG. 7B shows a case in which life of the flash EEPROM FMEM1 expires.

Up to the third state, the same procedure as described above is followed. In a fourth state, the operation-status flag of the SECTOR14-control area is set to “being used”. Each switch data generated thereafter is stored in the sector SECTOR14 at the data areas DATA-AREA1, DATA-AREA2, and so on, successively.

By this time, the number of erasures of the sectors SECTOR3 and SECTOR4 has reached a limit thereof, and it is recommended that the sectors SECTOR3 and SECTOR4 be not used any longer. The operation-status flags of the SECTOR3-control area and the SECTOR4-control area are set to “unusable (life expired)”. It is preferable to inform of this fact by flashing light or the like.

Further, the operation-status flag of the SECTOR13-control area is changed from “used” to “waiting for erasure”. Upon this change, the sector SECTOR13 is promptly erased. When k-th switch data is written in the sector SECTOR14, a shift is made to a fifth state.

In the fifth state, since erasure of the sector SECTOR13 should be completed by this time, the operation-status flag of the SECTOR13-control area in the sector SECTOR1 is set to “being used”. Each switch data generated thereafter is stored in the sector SECTOR13 at the data areas DATA-AREA1, DATA-AREA2, and so on, successively. Also, the operation-status flag of the SECTOR14-control area in the sector SECTOR1 is set to “waiting for erasure”, so that the erasure of the sector SECTOR14 is immediately started. When k-th switch data is stored in the sector SECTOR13, another shift is made to a sixth state.

In the sixth state, the operation-status flag of the SECTOR14-control area in the sector SECTOR1 is set to “being used”. Each switch data generated thereafter is stored in the sector SECTOR14 at the data areas DATA-AREA1, DATA-AREA2, and so on, successively.

In this example, a maintenance engineer who noticed the flashing light replaces the flash EEPROM FMEM1 with a new flash EEPROM FMEM1 since the sectors SECTOR3 and SECTOR4 have life thereof expired. This replacement is carried out without bringing the system to a halt. Then, the operation-status flag of the SECTOR13-control area in the sector SECTOR1 is changed to “used”. When k-th switch data is written in the sector SECTOR14, a state is shifted to a seventh state. Thereafter, the same procedure as in the normal operation previously described will be followed.

According to the embodiment described above, when one of the flash EEPROMs is expired, one of the remaining flash EEPROMs is used to enable a data-backup operation.

Alternatively, an available sector or a sector which has been assigned to another data type may be newly assigned to the data type experiencing shortage of sectors, so that the flash EEPROM having therein a sector or sectors of expired life can be used without a replacement so as to continue the data-backup operation.

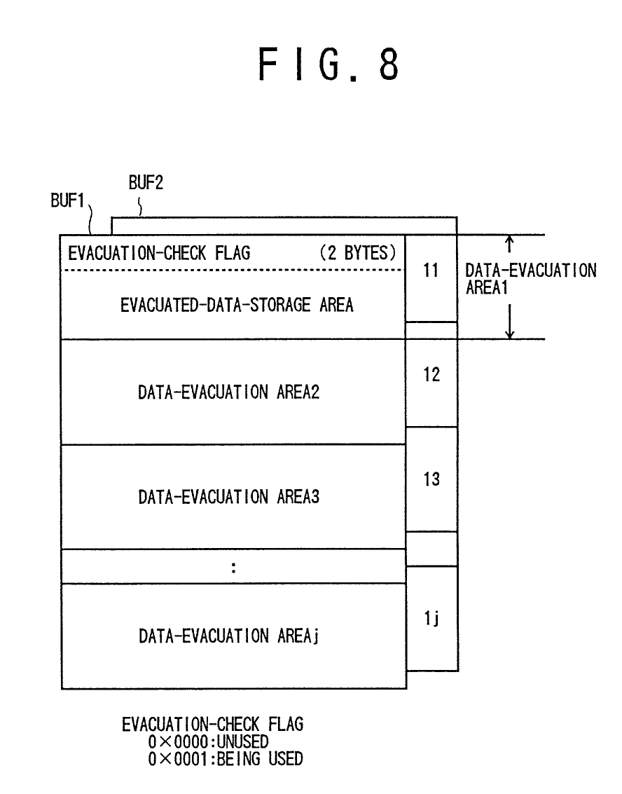

FIG. 8 is an illustrative drawing for explaining a memory map of the buffer-memory module 36 according to the embodiment of the present invention.

As previously described, the buffer-memory module (data-evacuation buffers) 36 is used as a temporal data-evacuation means used when a data-write operation needs to be deferred. If application of the device does not involve such a situation (e.g., if only a small amount of data is generated), then, the buffer-memory module 36 can be omitted from the configuration.

In the figure, the buffer memories (evacuation buffers) BUF1 and BUF2 (e.g., 64 kbyte each) are provided for each of the data types, and store incoming data on a temporary basis. When the flash EEPROM FMEM1 or FMEM2 is available for data writing, the stored data is read from the evacuation buffers by a predetermined unit of data amount (e.g., by a unit of one byte when hardware requirements are considered), and is written in the flash EEPROM FMEM1 or FMEM2.

Each of the buffer memories BUF1 and BUF2 has a memory area divided into a plurality of data-evacuation areas DATA-EVACUATION-AREA1 through DATA-EVACUATION-AREAj and DATA-EVACUATION-AREA11 through DATA-EVACUATION-AREA1j, each of which is sufficiently large to accommodate the incoming data by the predetermined unit of data amount. A used/unused condition of each area (i.e., indicating whether data is stored therein) is controlled by an evacuation-check flag.

An example of the contents of the evacuation-check flag is shown in the following:

“no data evacuated in buffer”: 0x000; and

“data evacuated in buffer”: 0x0001.

Each of the buffer memories BUF1 and BUF2 employs a FIFO-type buffer. First incoming data is stored in the data-evacuation areas DATA-EVACUATION-AREA1 and DATA-EVACUATION-AREA11, and is read therefrom ahead of other data. Second incoming data is stored in the data-evacuation areas DATA-EVACUATION-AREA2 and DATA-EVACUATION-AREA12, and is read therefrom after the first incoming data but ahead of other data. The same applies in the case of other data-evacuation areas. After the data-evacuation areas DATA-EVACUATION-AREAj and DATA-EVACUATION-AREA1j are used, it goes back to the top, and the data-evacuation areas DATA-EVACUATION-AREA1 and DATA-EVACUATION-AREA11 are used. Then, the procedure repeats in a cyclic manner.

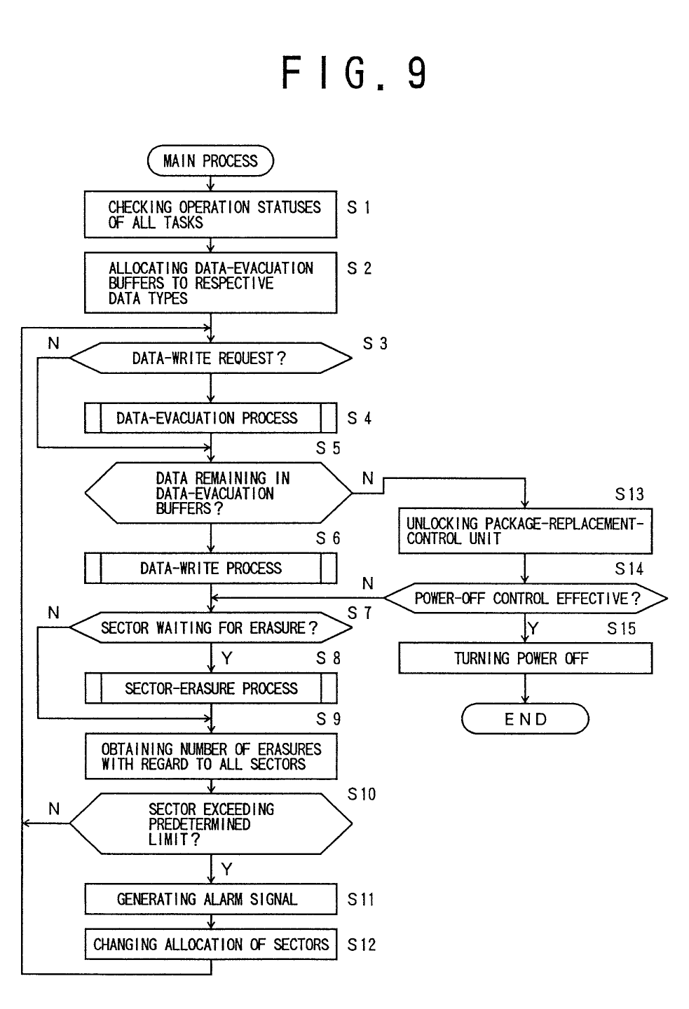

FIG. 9 is a flowchart of a data-backup process according to the embodiment of the present invention.

The process shown in FIG. 9 is a main process performed by the OS processes and the FMEM-control process of the CPU 31 shown in FIG. 4.

At a step S1, a check is made with respect to operation statuses of all tasks. At a step S2, data-evacuation buffers are allocated to respective data types. At a step S3, a check is made as to whether a data-write request is made by the control board 10. If the request is made, incoming data is stored in a corresponding data-evacuation buffer at a step S4. Otherwise, the procedure skips the step S4.

At a step S5, a check is made whether there is data remaining in the data-evacuation buffers. If there is, at a step S6, the remaining evacuated data is stored in the flash EEPROM FMEM1 or FMEM2, and the procedure goes to a step S7. If there is no such data at the step S5, the procedure goes to a step S13. At a step S13, the package-replacement-control unit 33 is changed from a locked condition to an unlocked condition since removal of the file board 30 will cause no trouble. At a step S14, a check is made whether power-off control is effective. If it is not effective, the procedure goes to the step S7. Otherwise, the procedure toes to a step S15, where the power is turned off. This ends the procedure. Here, the processes of the steps S14 and S15 may alternatively be performed by the CPU 11 of FIG. 4.

At the step S7, a check is made whether there is a sector waiting for erasure. It there is, the sector is erased at a step S8. If there is no sector waiting for erasure, the step S8 will be skipped.

At a step S9, the number of erasures are obtained with regard to all the sectors. At a step S10, a check is made whether there is a sector that exceeds a predetermined limit (i.e., is overdue in terms of life). If there is no such sector, the procedure goes back to the step S3. If there is such a sector, an alarm signal is generated at a step S11 to inform a maintenance worker. At a step S12, allocation of sectors for storing data is renewed (changed). Namely, an available sector or a sector allocated to another data type is newly allocated to the data type which is using the overdue sector.

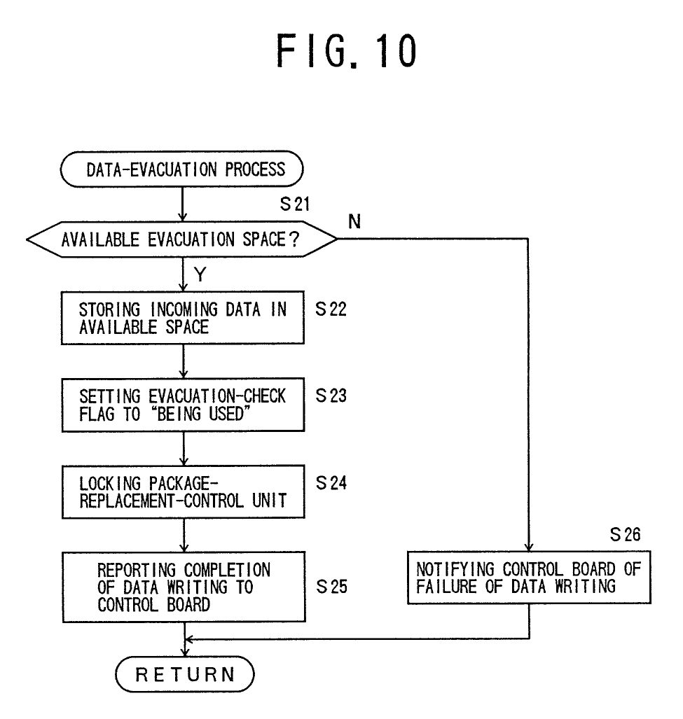

FIG. 10 is a flowchart of a data-evacuation process storing data in a data-evacuation buffer. This process is that of the step S4 of FIG. 9, and is mainly performed by the buffer-evacuation process of the CPU 31 of FIG. 4.

At a step S21, a check is made as to whether there is an available evacuation space in a data-evacuation buffer relevant to the data type of the incoming data. If there is, the incoming data is stored in the available space at a step S22. At a step S23, an evacuation-check flag is set to “being used” (indicative of presence of data). At a step S24, the package-replacement-control unit 33 is set to a locked condition so as to avoid removal of the file board 30 and erasure of the data stored in the data-evacuation buffer. At a step S25, a completion of data writing is reported to the control board 10. This ends the process.

If there is no available evacuation space at the step S21, the procedure goes to a step S26. At the step S26, the control board 10 is notified that the data writing ended in failure.

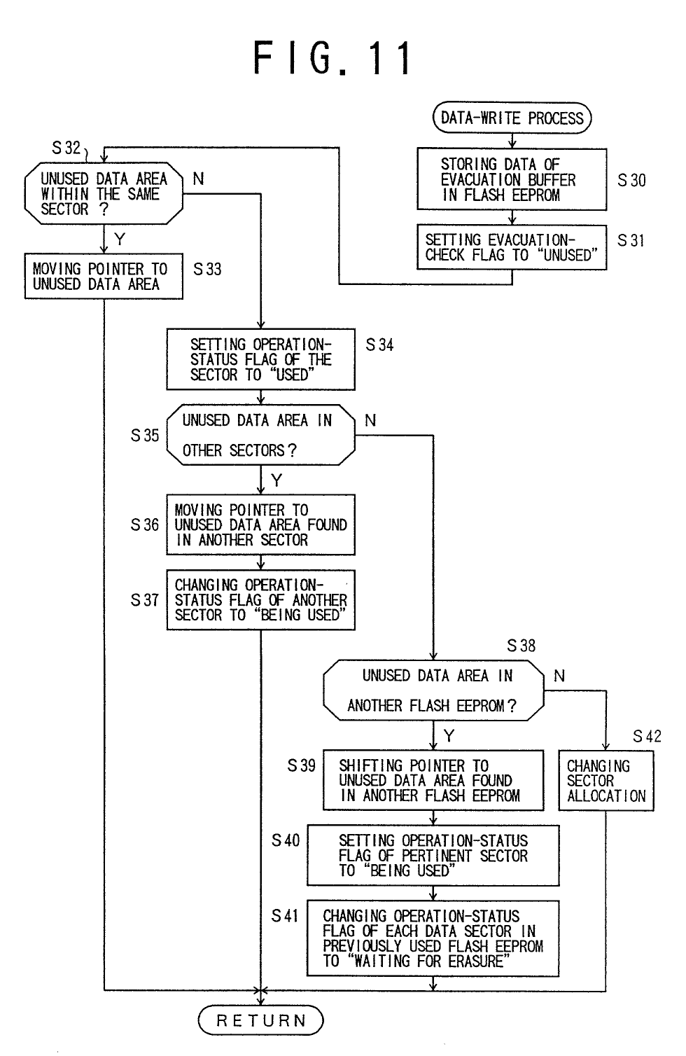

FIG. 11 is a flowchart of a data-write process transferring data from a data-evacuation buffer to a flash EEPROM. This process is that of the step S6 of FIG. 9, and is mainly performed by the FMEM-write process of the CPU 31 of FIG. 4.

It should be noted that the flash EEPROM FMEM1/FMEM2 has only a limited resource available for the purpose of storing data supplied from the evacuation buffer. Because of this, an available area may be searched for immediately before the writing of data. Alternatively, an area available for a next write operation is set aside as soon as a current write operation is finished, so that the next write operation does not have to wait before writing of data. In the following, the latter scheme will be described.

At a step S30, the data of the evacuation buffer is stored in a preassigned unused area of the flash EEPROM FMEM1/FMEM2. Along with this data, necessary header information is also stored. At a step S31, an evacuation-check flag of the evacuation buffer is set to “unused”. At a step S32, a check is made as to whether there is an unused data area within the same sector. If there is, a pointer (i.e., an address for writing next data) is moved to this unused data area at a step S33, and the same procedure is repeated. The pointer may be controlled by and/or stored as a backup in an appropriate area of the flash EEPROM so as to prevent the pointer information from being lost at a time of power off or the like.

If there is no unused data area at the step S32, the procedure goes to a step S34, where an operation-status flag of the sector is set to “used”. At a step S35, a check is made as to whether there is an unused data area in other sectors within the same device. If there is, at a step S36, the pointer is moved to this unused data area found in another sector. At a step S37, the operation-status flag of this sector is changed to “being used”.

If no available data area is found at the step S32 in other sectors in the same device, a check is made at a step S38 as to whether there is an unused data area in another flash EEPROM. If there is, the pointer is shifted to indicate the newly found unused data area. At a step S40, the operation-status flag of the pertinent sector of this flash EEPROM is set to “being used”. At a step S41, the operation-status flag of each data sector in the previously used flash EEPROM is changed to “waiting for erasure”.

If no available data area is found at the step S38 in other flash EEPROMs, sector allocation regarding the current data type is changed at a step S42. Alternatively, an error flag informing of a lack of data sectors may be put up. Thereafter, the remaining part of the procedure is continued.

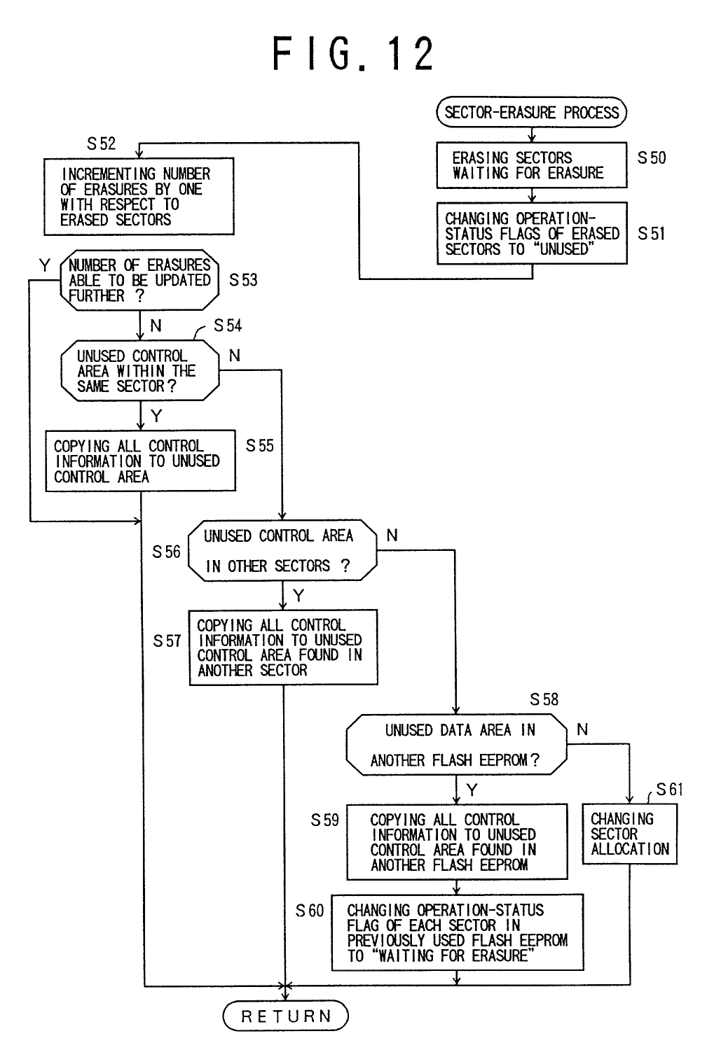

FIG. 12 is a flowchart of a sector-erasure process of the step S8 shown in FIG. 9. This process is mainly performed by the sector-erasure process of the CPU 31 of FIG. 4.

At a step S50, sectors having the operation-status flags thereof set to “waiting for erasure” are erased. At a step S51, the operation-status flags of the erased sectors are changed to “unused”. At a step S52, the number of erasures is incremented by one with respect to each of the erased sectors. At a step S53, a check is made as to whether the number of erasures can be updated further (i.e., whether the number can be further counted by successively dropping one bit from the lower sixteen bits of the counter). If further updating is possible, the remaining part of the procedure is continued. If further updating is not possible, a check is made at a step S54 as to whether there is an unused control area within the same sector. If there is, the control information on all the sectors is copied to the unused control area at a step S55. In the new control area for controlling the sectors, the upper sixteen bits of the erasure-number counter is incremented by one, and the lower sixteen bits thereof is initialized to 0xffff. Then, the remaining part of the procedure will be continued.

If no available control area is found at the step S54 within the same sector, a check is made at a step S56 as to whether there is an unused control area in other sectors in the same device. If there is, all the control information is copied to the unused control area found in another sector in the same device. Then, the remaining part of the procedure will be continued.

If no available control area is found at the step S56 in other sectors in the same device, a check is made at a step S58 as to whether there is an unused data area in another flash EEPROM. If there is, at a step S59, all the control information is copied to the unused control area newly found in another flash EEPROM. At a step S60, the operation-status flag of each sector in the previously used flash EEPROM is changed to “waiting for erasure”.

If no available control area is found at the step S58 in other flash EEPROMs, sector allocation regarding the control data is changed at a step S61. Alternatively, an error flag informing of a lack of control sectors may be put up. Thereafter, the remaining part of the procedure is continued.

The description in connection with FIG. 9 has been given with reference to a case in which the data stored in the buffer memory BUF1/BUF2 can be written in the flash EEPROM FMEM1/FMEM2 at any time convenient for the operation. When the sectors SECTOR3, SECTOR4, SECTOR13, and SECTOR14 are recursively used for the switch data, for example, such conditions (warranting data transfer of any timing) may be materialized. In such a case, the evacuation buffers are not necessary.

When sectors SECTOR5, SECTOR6, SECTOR15, and SECTOR16 are recursively used for the alarm data, however, a problem may arise from a difference, for example, in the amount of generated data between the switch data and the alarm data. Because of such a difference, it is possible to have a situation in which writing of switch data in the sector SECTOR3 collides with the data erasure operation regarding the sectors SECTOR5 and SECTOR6.

In this case, a check process may be inserted between the step S5 and the step S6 of FIG. 9 so as to check whether an erasure operation is underway with respect to the device that is to be subjected to a data-write operation. If the erasure operation is underway, the step S6 is skipped. In such a configuration, switch data is accumulated in an evacuation buffer until the erasure process is completed for the sector SECTOR5 and SECTOR6. When it is completed, the switch data is transferred from the evacuation buffer to the sector SECTOR3.

The description of the embodiment has been given with reference to a case in which a flash EEPROM is used as a non-volatile memory that avails an erased memory area to a new data writing. The present invention, however, is not limited to the use of flash EEPROM, but is applicable to other non-volatile memory media such as an optical-magnetic disc, a phase-change-type disc, etc., as long as the same rewriting scheme is employed, i.e., as long as data is rewritten in a memory area after old data thereof is erased.

In the above description, further, the buffer-memory module 36 was provided as one of the elements. It is apparent, however, that the present invention can be implemented without the presence of the buffer-memory module 36.

Further, the present invention is not limited to these embodiments, but various variations and modifications may be made without departing from the scope of the present invention.

The present application is based on Japanese priority application No.10-158701 filed on Jun. 8, 1998, with Japanese Patent Office, the entire contents of which are hereby incorporated by reference.

What is claimed is:

1. A method of storing data in a non-volatile memory medium which permits data writing in a memory area after old data thereof is erased, comprising the steps of:
a) providing a data-storage area in each of a plurality of non-volatile memories with respect to each of different data types; and
b) writing incoming data of a given data type in a corresponding data-storage area in a first one of the non-volatile memories while a second one of the non-volatile memories is being subjected to data erasure of the given data type after a corresponding data-storage area in the second one of the non-volatile memories is filled with the incoming data of the given data type.

2. The method as claimed in claim 1, wherein said step a) provides a plurality of sectors as the data-storage area in each of the plurality of non-volatile memories with respect to each of the different data types, wherein each of the plurality of non-volatile memories has data thereof erased by a unit of one sector.

3. The method as claimed in claim 1, further comprising a step of providing an evacuation buffer for each of the different data types, wherein said step b) comprises the steps of:
writing the incoming data of the given data type in a corresponding evacuation buffer and immediately transferring the incoming data from the corresponding evacuation buffer to the first one of the non-volatile memories when the first one of the non-volatile memories is available for data writing; and
continuing writing the incoming data of the given data type in the corresponding evacuation buffer when the first one of the non-volatile memories is being subjected to data erasure of a different data type, and transferring the incoming data from the corresponding evacuation buffer to the first one of the non-volatile memories when the first one of the non-volatile memories becomes available for data writing.

4. The method as claimed in claim 3, further comprising the steps of:
providing a replacement enabling unit in order to control a locked/unlocked condition of the non-volatile memories in terms of whether the non-volatile memories are locked in place; and
setting the replacement enabling unit to the locked condition when the evacuation buffer keeps therein data that has not been stored in the non-volatile memories.

5. The method as claimed in claim 2, further comprising a step of erasing used ones of the plurality of sectors in a given one of the non-volatile memories when writing the incoming data of the given data type in the plurality of sectors in the given one of the non-volatile memories if all the other ones of the non-volatile memories are in condition for needing replacement thereof.

6. The method as claimed in claim 2, further comprising a step of allocating another sector to the given data type when shortage of sectors is observed with regard to the plurality of sectors provided for the given data type.

7. A method of storing data in a non-volatile memory medium which permits data writing in a memory area after old data thereof is erased, comprising the steps of:
a) providing control-data areas for respective non-volatile memories in each of the non-volatile memories such that each of the control-data areas stores operation statuses of a corresponding one of the non-volatile memories; and
b) copying contents of a control-data area in a first one of the non-volatile memories to a control-data area in a second one of the non-volatile memories before erasing the control-data area in the first one of the non-volatile memories, thereby effecting continued control of the operation statuses of a corresponding one of the non-volatile memories.

8. The method as claimed in claim 7, wherein said step a) provides a plurality of sectors for the control areas in each of the non-volatile memories, wherein each of the non-volatile memories has data thereof erased by a unit of one sector.

9. The method as claimed in claim 8, further comprising a step of recording the operation statuses of a given one of the non-volatile memories in a corresponding control-data area with respect to each sector of the given one of the non-volatile memories.

10. The method as claimed in claim 8, further comprising the steps of:
c) writing operation statuses in the plurality of sectors in one of the non-volatile memories;
d) writing operation statuses in the plurality of sectors in another one of the non-volatile memories after using all the plurality of sectors in said one of the non-volatile memories, and erasing the plurality of sectors in said one of the non-volatile memories; and
repeating said steps c) and d) so as to effect recursive use of the plurality of sectors in the non-volatile memories.

11. The method as claimed in claim 8, further comprising a step of erasing used ones of the plurality of sectors in a given one of the non-volatile memories when writing operation statuses in the plurality of sectors in the given one of the non-volatile memories if all the other ones of the non-volatile memories are in condition for needing replacement thereof.

12. The method as claimed in claim 8, further comprising a step of allocating another sector to the control-data area when shortage of sectors is observed with regard to the plurality of sectors provided for the control-data area.

13. A method of storing data in a non-volatile memory medium which permits data writing in a memory area after old data thereof is erased, comprising the steps of:
providing a memory area which stores a number of occurrences of a given event in a non-volatile memory;
setting a first bit state in all bits of the memory area as initialization thereof; and
changing one of predetermined bits of the memory area from the first bit state to a second bit state each time the given event occurs, thereby counting the number of occurrences of the given event without a need for erasing the memory area.

14. The method as claimed in claim 13, further comprising the steps of:
providing a plurality of memory areas functioning in the same manner as the memory area; and
moving from a first one of the memory areas to the second one of the memory areas when all the predetermined bits of the first one of the memory areas are changed for the counting of the number of occurrences of the given event, wherein remaining bits other than the predetermined bits are used for counting the number of occurrences of said moving based on a binary coded decimal, thereby counting the number of occurrences of the given event up to a number of the predetermined bits multiplied a number of the memory areas without a need for erasing the memory area.

15. A device for storing data in a non-volatile memory medium which permits data writing in a memory area after old data thereof is erased, comprising:
a plurality of non-volatile memories each having a data-storage area therein provided for each of different data types; and
a unit configured to write incoming data of a given data type in a corresponding data-storage area in a first one of said non-volatile memories while a second one of said non-volatile memories is being subjected to data erasure of the given data type after a corresponding data-storage area in the second one of said non-volatile memories is filled with the incoming data of the given data type.

16. The device as claimed in claim 15, wherein each of said non-volatile memories has a plurality of sectors provided as the data-storage area for each of the different data types, and has data thereof erased by a unit of one sector.

17. The device as claimed in claim 15, further comprising
an evacuation buffer provided for each of the different data types,
wherein said unit writes the incoming data of the given data type in a corresponding evacuation buffer to immediately transfer the incoming data from said corresponding evacuation buffer to the first one of said non-volatile memories when the first one of said non-volatile memories is available for data writing, and continues writing the incoming data of the given data type in said corresponding evacuation buffer when the first one of said non-volatile memories is being subjected to data erasure of a different data type, so as to transfer the incoming data from said corresponding evacuation buffer to the first one of said non-volatile memories when the first one of said non-volatile memories becomes available for data writing.

18. The device as claimed in claim 17, further comprising
a replacement enabling unit configured to control a locked/unlocked condition of said non-volatile memories in terms of whether said non-volatile memories are locked in place,
wherein said unit sets the replacement enabling unit to the locked condition when said evacuation buffer keeps therein data that has not been stored in said non-volatile memories.

19. The device as claimed in claim 16, wherein said unit erases used ones of the plurality of sectors in a given one of said non-volatile memories when writing the incoming data of the given data type in the plurality of sectors in the given one of said non-volatile memories if all the other ones of said non-volatile memories are in condition for needing replacement thereof.

20. The device as claimed in claim 16, wherein said unit allocates another sector to the given data type when shortage of sectors is observed with regard to the plurality of sectors provided for the given data type.

21. A device for storing data in a non-volatile memory medium which permits data writing in a memory area after old data thereof is erased, comprising:
non-volatile memories each having therein control-data areas provided for the respective non-volatile memories such that each of the control-data areas stores operation statuses of a corresponding one of said non-volatile memories; and
a unit configured to copy contents of a control-data area in a first one of said non-volatile memories to a control-data area in a second one of said non-volatile memories before erasing the control-data area in the first one of said non-volatile memories, thereby effecting continued control of the operation statuses of a corresponding one of said non-volatile memories.

22. The device as claimed in claim 21, wherein each of said non-volatile memories has a plurality of sectors therein provided for the control areas, and has data thereof erased by a unit of one sector.

23. The device as claimed in claim 22, wherein said unit records the operation statuses of a given one of said non-volatile memories in a corresponding control-data area with respect to each sector of the given one of said non-volatile memories.

24. The device as claimed in claim 22, wherein said unit writes operation statuses in the plurality of sectors in one of said non-volatile memories, and writes operation statuses in the plurality of sectors in another one of said non-volatile memories after using all the plurality of sectors in said one of said non-volatile memories while erasing the plurality of sectors in said one of said non-volatile memories, thereby effecting recursive use of the plurality of sectors in said non-volatile memories.

25. The device as claimed in claim 22, wherein said unit erases used ones of the plurality of sectors in a given one of said non-volatile memories when writing operation statuses in the plurality of sectors in the given one of said non-volatile memories if all the other ones of said non-volatile memories are in condition for needing replacement thereof.

26. The device as claimed in claim 22, wherein said unit allocates another sector to the control-data area when shortage of sectors is observed with regard to the plurality of sectors provided for the control-data area.

27. A device of storing data in a non-volatile memory medium which permits data writing in a memory area after old data thereof is erased, comprising:
a non-volatile memory having therein a memory area which stores a number of occurrences of a given event; and
a unit configured to set a first bit state in all bits of the memory area as initialization thereof, and to change one of predetermined bits of the memory area from the first bit state to a second bit state each time the given event occurs, thereby counting the number of occurrences of the given event without a need for erasing the memory area.

28. The device as claimed in claim 27, wherein said non-volatile memory has a plurality of memory areas functioning in the same manner as the memory area, and wherein said unit switches a memory area for the counting from a first one of the memory areas to the second one of the memory areas when all the predetermined bits of the first one of the memory areas are changed from the first bit state to the second bit state, and uses remaining bits other than the predetermined bits for counting the number of occurrences of the switching of a memory area based on a binary coded decimal, thereby counting the number of occurrences of the given event up to a number of the predetermined bits multiplied a number of the memory areas without a need for erasing the memory area.

29. A device for storing data in a non-volatile memory medium which permits data writing in a memory area after old data thereof is erased, comprising:
a plurality of non-volatile memories each having a data-storage area therein provided for each of different data types; and
means for writing incoming data of a given data type in a corresponding data-storage area in a first one of said non-volatile memories while a second one of said non-volatile memories is being subjected to data erasure of the given data type after a corresponding data-storage area in the second one of said non-volatile memories is filled with the incoming data of the given data type.

30. A device for storing data in a non-volatile memory medium which permits data writing in a memory area after old data thereof is erased, comprising:
non-volatile memories each having therein control-data areas provided for the respective non-volatile memories such that each of the control-data areas stores operation statuses of a corresponding one of said non-volatile memories; and
means for copying contents of a control-data area in a first one of said non-volatile memories to a control-data area in a second one of said non-volatile memories before erasing the control-data area in the first one of said non-volatile memories, thereby effecting continued control of the operation statuses of a corresponding one of said non-volatile memories.

31. A device of storing data in a non-volatile memory medium which permits data writing in a memory area after old data thereof is erased, comprising:
a non-volatile memory having therein a memory area which stores a number of occurrences of a given event; and
means for setting a first bit state in all bits of the memory area as initialization thereof, and for changing one of predetermined bits of the memory area from the first bit state to a second bit state each time the given event occurs, thereby counting the number of occurrences of the given event without a need for erasing the memory area.
